(19) United States
(12) Patent Application Publication
(10) Pub. No.: US 2025/0367810 A1
(43) Pub. Date: Dec. 4, 2025

(54) AUXILIARY GRIP FOR STRIKING TOOL

(71) Applicant: MAKITA CORPORATION, Anjo-shi (JP)

(72) Inventors: Yoshitaka MACHIDA, Anjo-shi (JP); Mizuki Yamamoto, Anjo-shi (JP); Takumi Sugisaka, Anjo-shi (JP)

(73) Assignee: MAKITA CORPORATION, Anjo-shi (JP)

(21) Appl. No.: 19/081,221

(22) Filed: Mar. 17, 2025

(30) Foreign Application Priority Data
May 31, 2024 (JP) 2024-088789

(51) Int. Cl. B25F 5/02; B23B 45/00; B23B 45/02; B25D 16/00

(52) U.S. Cl. CPC B25F 5/026; B23B 45/001; B23B 45/008; B23B 45/02; B25D 16/00

(57) ABSTRACT

An auxiliary grip includes a shock absorber with a reduced size. The auxiliary grip attachable to a striking tool includes a base and a grip body. The base is to extend in a direction intersecting with a striking axis of the striking tool. The base includes at least one elastic member. The grip body covers the base. The grip body is held by the base to be urged by the at least one elastic member in two directions along the striking axis.

### CROSS-REFERENCE TO RELATED APPLICATIONS

This application claims the benefit of priority to Japanese Patent Application No. 2024-088789, filed on May 31, 2024, the entire contents of which are hereby incorporated by reference.

### BACKGROUND

### 1. Technical Field

The disclosure relates to an auxiliary grip for, for example, a striking tool referred to as a hammer drill.

### 2. Description of the Background

A striking tool referred to as a hammer drill described in U.S. Pat. No. 9,242,363 includes a main handle grippable by an operator with one hand and an auxiliary grip grippable with the other hand. The operator holds the striking tool with both hands and performs, for example, drilling on concrete walls or chipping on concrete floors. Thus, the auxiliary grip includes, for example, a shock absorber to absorb an impact generated by the tool body performing striking.

### BRIEF SUMMARY

In a known auxiliary grip, a cushioning member such as a sponge is held between the auxiliary grip and a grip base connected to the tool body. This reduces an impact transmitted to the operator's hands. However, when the cushioning member includes compression springs arranged in series, a larger shock absorber is to be used.

One or more aspects of the disclosure are directed to an auxiliary grip including a shock absorber with a reduced size.

A first aspect of the disclosure provides an auxiliary grip attachable to a striking tool, the auxiliary grip including:
a base to extend in a direction intersecting with a striking axis of the striking tool, the base including at least one elastic member; and
a grip body covering the base, the grip body being held by the base to be urged by the at least one elastic member in two directions along the striking axis.

A second aspect of the disclosure provides a striking tool, including:
the auxiliary grip described above.

The auxiliary grip according to the above aspects of the disclosure includes a shock absorber with a reduced size.

### BRIEF DESCRIPTION OF DRAWINGS

FIG. 1 is a longitudinal sectional view of a striking tool with an auxiliary grip attached to extend downward.

FIG. 2 is a perspective view of the auxiliary grip in a lateral orientation extending leftward from the striking tool as viewed diagonally from the right rear.

FIG. 3 is a perspective view of the auxiliary grip in the lateral orientation extending leftward from the striking tool as viewed diagonally from the left rear and above.

FIG. 4 is a top view of the auxiliary grip.

FIG. 5 is a top view of a base in the auxiliary grip with a grip body shown in a horizontal section.

FIG. 6 is a perspective view of the base as viewed diagonally from the left rear and above.

FIG. 7 is a perspective view of a shock absorber in the base as viewed diagonally from the right rear.

FIG. 8 is a sectional view taken along line VIII-VIII in FIG. 5 showing a longitudinal section of the shock absorber, as viewed in the direction indicated by the arrows.

FIG. 9 is a right side view of the grip body.

FIG. 10 is a perspective view of the grip body as viewed diagonally from the left rear.

FIG. 11 is a top view of the auxiliary grip in a left lateral orientation attached to the left of the tool body.

FIG. 12 is a top view of the auxiliary grip in a right lateral orientation attached to the right of the tool body.

### DETAILED DESCRIPTION

### Embodiments

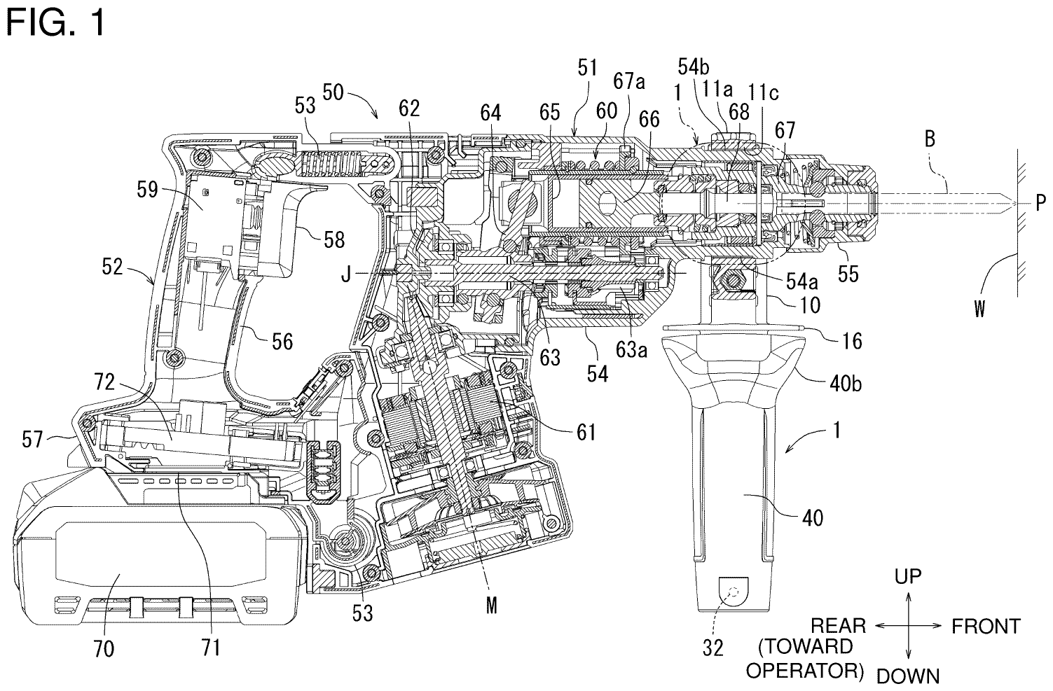

As shown in FIG. 1, an auxiliary grip 1 is attached to a striking tool 50 referred to as a hammer drill. The striking tool 50 is a relatively large hand-held tool. The striking tool 50 includes a tool body 51 and a handle 52. The tool body 51 accommodates a striking assembly 60. The handle 52 has a looped shape and is grippable by an operator. Multiple sets of vibration isolators 53 are held between the tool body 51 and the handle 52. The tool body 51 and the handle 52 are not joined rigidly, but are supported elastically on each other in a vibration isolating structure. Each vibration isolator 53 mainly includes compression coil springs. The vibration isolator 53 absorbs an impact generated by the striking assembly 60 in the tool body 51 and reduces transmission of the impact to the handle 52.

The tool body 51 includes a body housing 54. The body housing 54 accommodates the striking assembly 60. The striking assembly 60 includes an electric motor 61 as a drive source. The electric motor 61 is supported in a rearward-tilting orientation with an upper portion along a motor axis M tilting rearward. The rotational output from the electric motor 61 is transmitted to a countershaft 63 through a bevel gear 62. The countershaft 63 is rotatably supported about an axis J in a lateral orientation with the axis J extending in the front-rear direction.

In response to rotation of the countershaft 63, a power converter 64 tilts frontward and rearward. The power converter 64 is connected to a piston 65. In response to rotation of the countershaft 63, the piston 65 thus reciprocates back and forth. This generates air pressure, and a striker 66 moves forward to be in contact with an intermediate member 68. The intermediate member 68 strikes the rear end of a drill bit B. Thus, the drill bit B strikes a workpiece W (e.g., concrete wall surface). In this embodiment, the axis of the drill bit B corresponds to a striking axis P. The drill bit B strikes forward in a direction along the striking axis P.

The countershaft 63 includes a gear 63a in its front portion. The gear 63a is meshed with a holder gear 67a. The holder gear 67a is connected to the outer circumference of a tool holder 67. In response to rotation of the countershaft 63, the tool holder 67 thus rotates about the striking axis P. The tool holder 67 has a cylindrical rear portion. The tool holder 67 accommodates, in its inner space, the piston 65 and the striker 66 in a reciprocating manner. The drill bit B is removably attached to the front of the tool holder 67. The body housing 54 includes a chuck 55 in its front portion. The drill bit B protrudes frontward from the chuck 55. In response to rotational output from the electric motor 61, the drill bit B attached to the tool holder 67 rotates about the striking axis P and strikes in the direction along the striking axis P.

The handle 52 has a looped shape and extends between an upper rear portion and a lower rear portion of the tool body 51. The handle 52 includes a grip 56 and a handle base 57. The grip 56 is grippable by the operator. The handle base 57 includes a front portion connected to the lower rear portion of the tool body 51 with a vibration isolator 53 between them. The grip 56 extends upward from a rear portion of the handle base 57. The grip 56 includes an upper portion connected to the upper rear portion of the tool body 51 with a vibration isolator 53 between them.

The grip 56 includes a switch lever 58 on its front surface. A switch body 59 is accommodated behind the switch lever 58 in the grip 56. The switch lever 58 is pulled rearward with a finger of the hand holding the grip 56 (e.g., right hand) to turn on the switch body 59 and activate the electric motor 61.

The handle base 57 includes a battery mount 71 on its lower surface. The battery mount 71 receives a single battery pack 70. The battery pack 70 is a rectangular prism. The battery pack 70 is a lithium-ion battery. The battery pack 70 is slid forward relative to the battery mount 71 for attachment. The electric motor 61 is powered by the attached battery pack 70. The handle base 57 accommodates a rectangular flat-plate controller 72. The controller 72 controls the operation of the electric motor 61.

The operator holds the striking tool 50 from the rear by holding the grip 56 of the handle 52 with one hand (e.g., right hand) and the auxiliary grip 1 with the other hand (e.g., left hand). Thus, the drill bit B faces the concrete wall surface (workpiece W) in front of or below the drill bit B. For components and structures described in the embodiments, the directional terms such as front, rear, left, right, up, and down are defined as viewed from the operator. Thus, the direction toward the operator is rearward.

The body housing 54 includes a cylindrical grip mount 54a in the front portion. The auxiliary grip 1 is attached to the grip mount 54a. The attached auxiliary grip 1 extends in a direction intersecting with the striking axis P.

The attached auxiliary grip 1 is loosened relative to the grip mount 54a to allow the auxiliary grip 1 to extend in any direction about the striking axis P. As indicated by the solid lines in FIG. 1, the auxiliary grip 1 may be used in a vertical orientation in which the auxiliary grip 1 extends downward from the grip mount 54a. As indicated by the two-dot-dash lines in FIG. 1, the auxiliary grip 1 may be used in a lateral orientation in which the auxiliary grip 1 extends leftward (in a direction perpendicular to the page of the figure) from the grip mount 54a. In most cases, the auxiliary grip 1 is used in the lateral orientation, and more specifically, in a left lateral orientation in which the auxiliary grip 1 is attached to protrude leftward substantially horizontally as viewed from the operator.

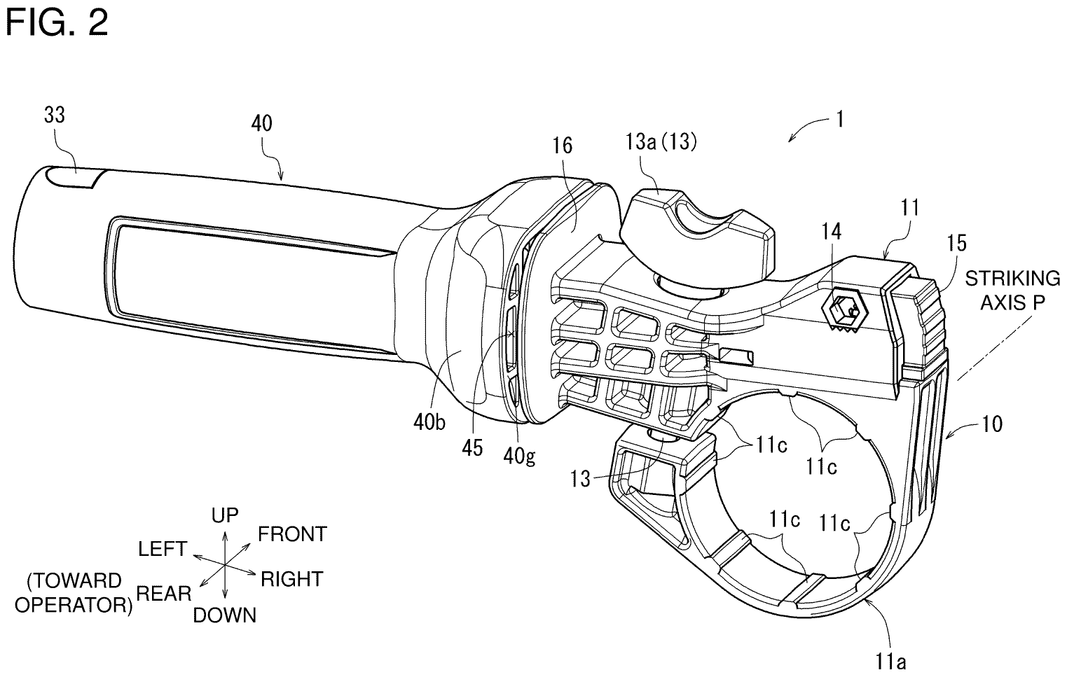

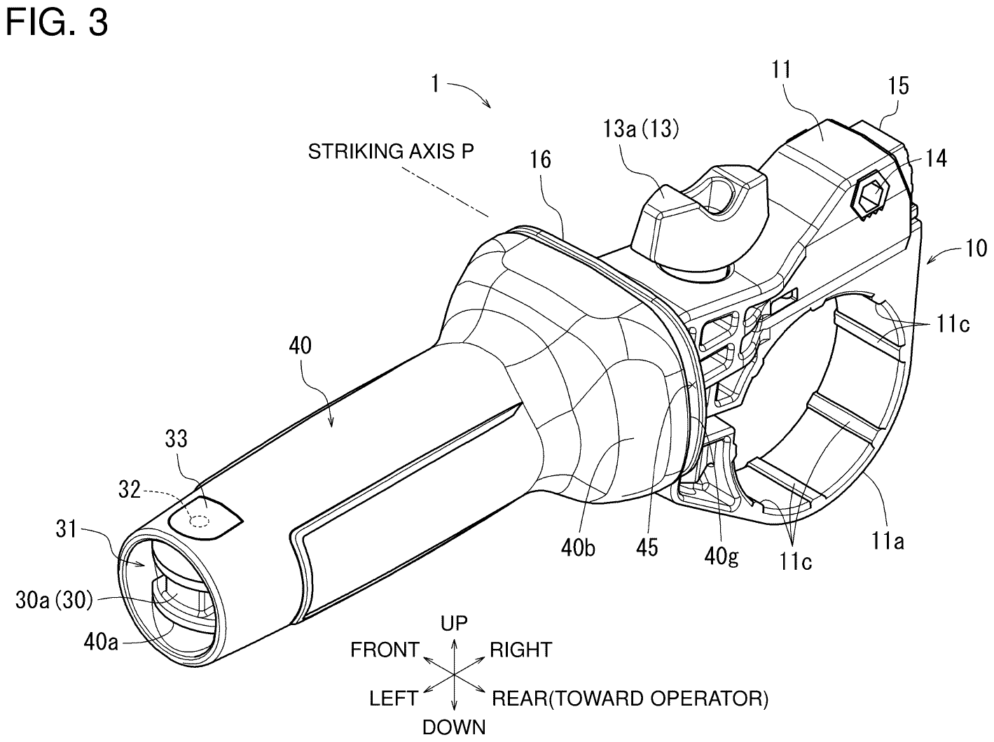

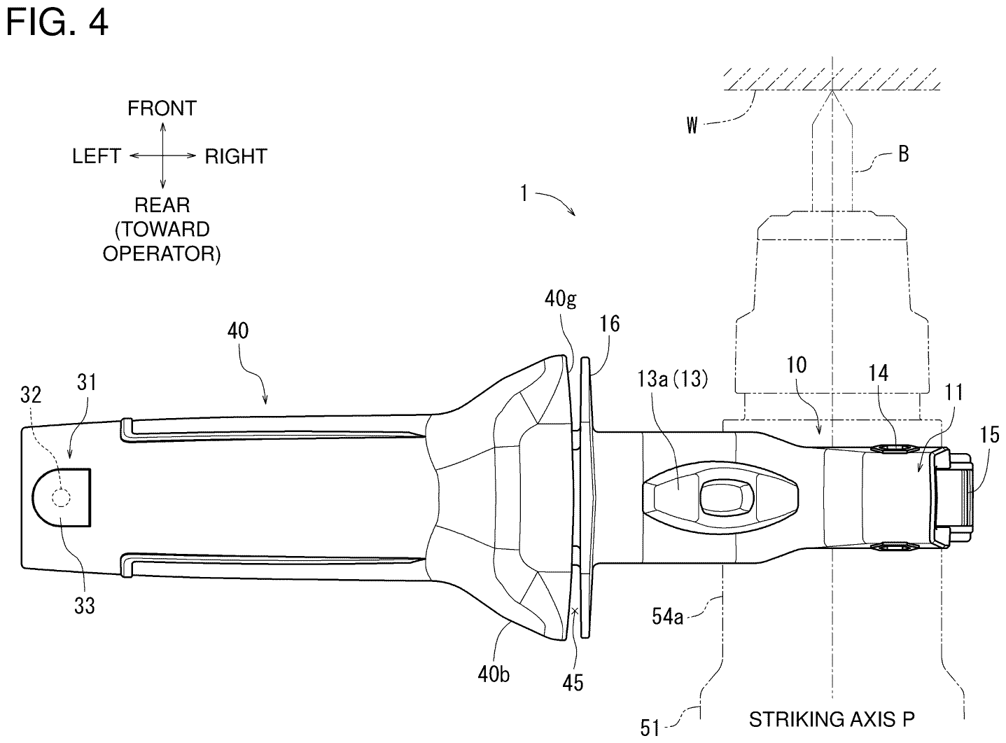

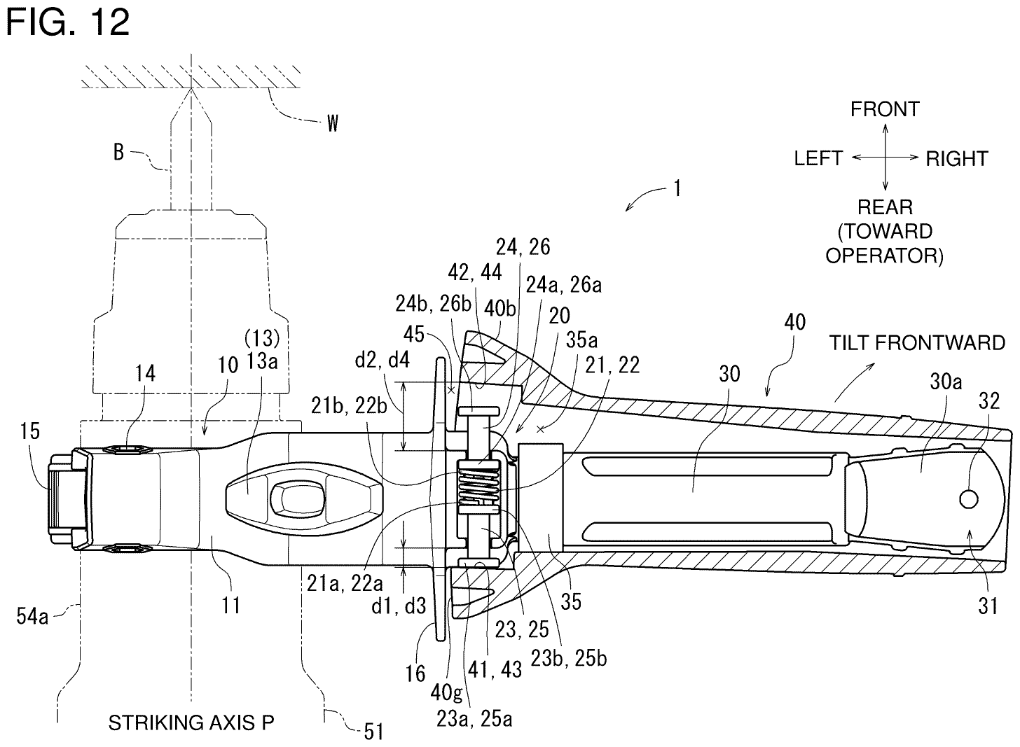

FIGS. 2 to 11 show the auxiliary grip 1 detached from the grip mount 54a. The auxiliary grip 1 can be used in the front, rear, left, right, up, and down directions with the left lateral orientation in which the auxiliary grip 1 protrudes leftward as a reference. The auxiliary grip 1 can be detached from the grip mount 54a to switch from the left lateral orientation to a right lateral orientation in which the auxiliary grip 1 protrudes rightward. FIG. 12 shows the auxiliary grip 1 attached in the right lateral orientation. The auxiliary grip 1 has the components and portions with their positions inverted between the left lateral orientation and the right lateral orientation in the font-rear direction. In the right lateral orientation, the operator holds the grip 56 with the left hand and the auxiliary grip 1 with the right hand. The auxiliary grip 1 attached in the right lateral orientation will be described later.

As shown in FIGS. 2 to 5, the auxiliary grip 1 includes a base 10 and a grip body 40. The base 10 protrudes leftward from the grip mount 54a to extend substantially horizontally. The base 10 includes a basal portion 11 and a distal portion 30. The basal portion 11 is attachable to the grip mount 54a. The grip body 40 is connected to the distal portion 30 to be tiltable in the direction along the striking axis P. The basal portion 11 includes an annular fastener 11a. The fastener 11a is deformable in a direction in which the diameter decreases as a fastening screw 13 is tightened. The grip mount 54a is placed on the inner circumference of the fastener 11a, and the fastening screw 13 is tightened. This fastens the base 10 to the grip mount 54a. The fastener 11a includes multiple engagement protrusions 11c on its inner circumference. Each of the multiple engagement protrusions 11c fits in the corresponding engagement recess 54b on the grip mount 54a. Thus, the position of the auxiliary grip 1 about the striking axis P is fixed.

The fastening screw 13 is a thumbscrew. The fastening screw 13 includes a projection 13a on its head. The operator pinches the projection 13a and turns the fastening screw 13 without using any dedicated tool. This loosens or tightens the fastener 11a.

The fastening screw 13 is loosened to allow the fastener 11a to elastically deform in a direction in which the diameter increases. This loosens the fastener 11a relative to the grip mount 54a. The auxiliary grip 1 can be moved frontward from the grip mount 54a to be detached from the striking tool 50. The fastener 11a is loosened relative to the grip mount 54a to allow the position change of the auxiliary grip 1 about the striking axis P. When the fastening screw 13 is tightened with the auxiliary grip 1 at a different position, another engagement protrusion 11c fits into the engagement recess 54b. The position of the auxiliary grip 1 about the striking axis P is thus fixed. This allows the auxiliary grip 1 to be selectively switchable between the vertical orientation (indicated by the solid lines in FIG. 1) in which the auxiliary grip 1 extends downward from the grip mount 54a and the lateral orientation in which the auxiliary grip 1 extends leftward or rightward. In the embodiment described below, the auxiliary grip 1 is fastened in the lateral orientation in which the auxiliary grip 1 extends leftward.

The fastener 11a includes, at its top, an auxiliary tool mount 14 that is a hexagonal hole. The auxiliary tool mount 14 receives, for example, an elongated rod-like stopper bar (not shown) parallel to the drill bit B. The stopper bar restricts the machining depth (hole depth) of the drill bit B. The drill bit B cuts into the concrete wall surface (workpiece W) until the stopper bar abuts against the concrete wall surface. This allows formation of numerous machined holes with a regular depth. A lock button 15 is located rightward from the auxiliary tool mount 14. Pressing the lock button 15 leftward loosens the auxiliary tool fastened to the auxiliary tool mount 14. This allows positional adjustment of the auxiliary tool in the front-rear direction, detaching the auxiliary tool from the auxiliary tool mount 14.

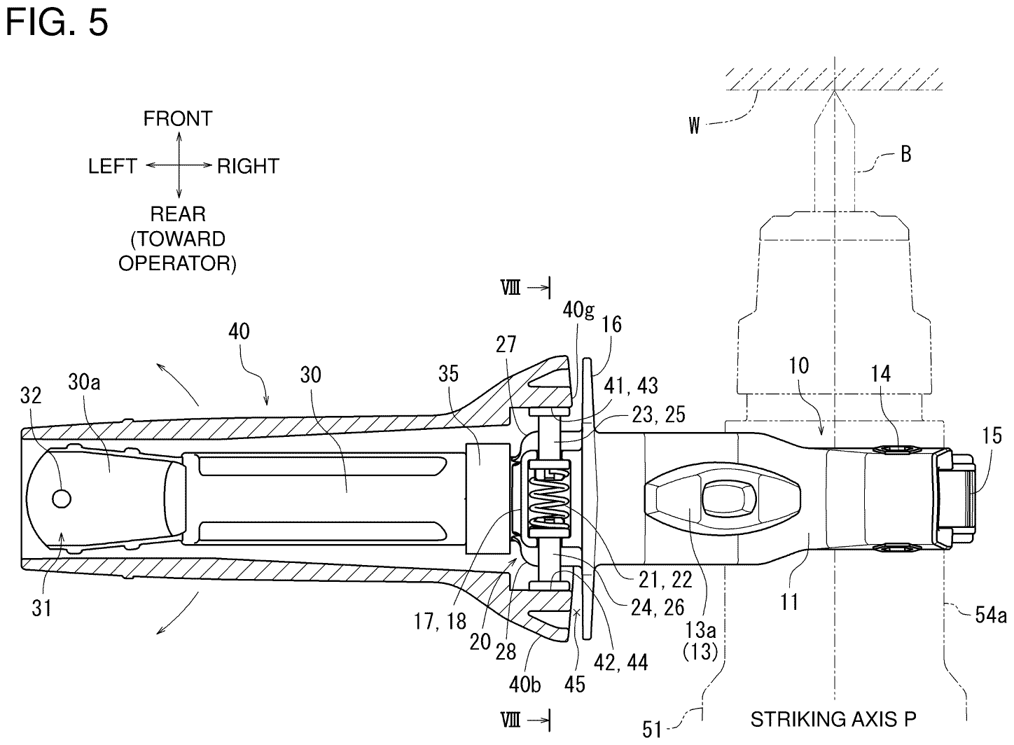

An oval flange 16 integral with the base 10 is on the left of the fastening screw 13. As shown in FIGS. 5 to 7, a shock absorber 20 is located on the left side surface of the flange 16. The distal portion 30 extends leftward from the left of the shock absorber 20. A single cushioning member 35 is located near the basal end of the distal portion 30 adjacent to the shock absorber 20. The shock absorber 20 and the cushioning member 35 will be described in detail later.

As shown in FIG. 5, the grip body 40 fully accommodates, in its inner space, the shock absorber 20, the cushioning member 35, and the distal portion 30, which are located leftward from the flange 16. The grip body 40 is cylindrical and surrounds the distal portion 30. The grip body 40 is connected to the left end of the distal portion 30 with a connecting portion 31.

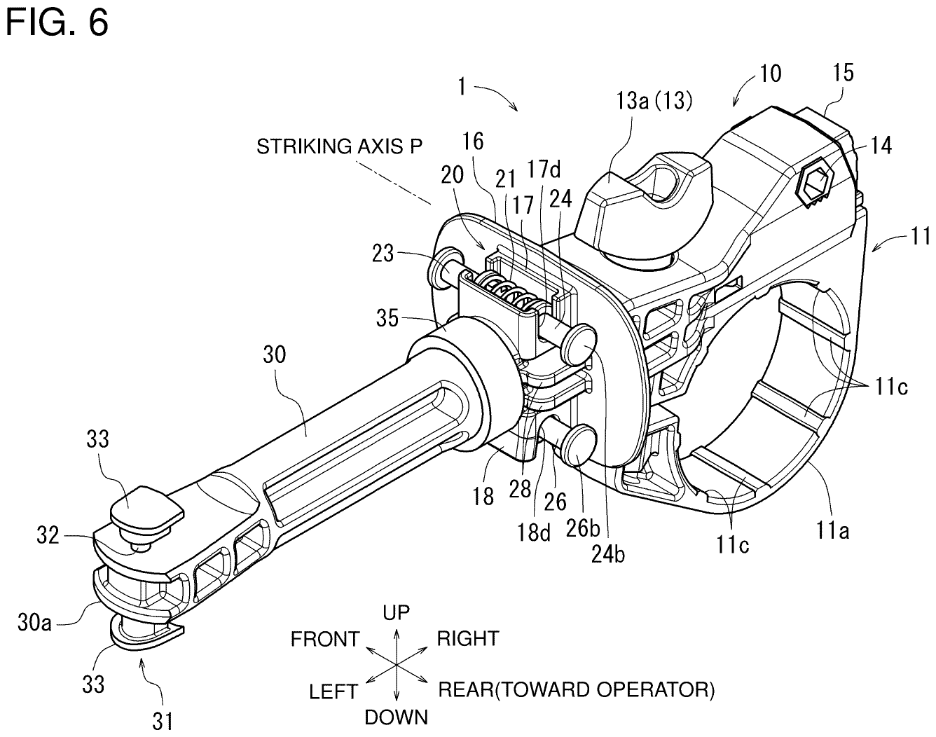

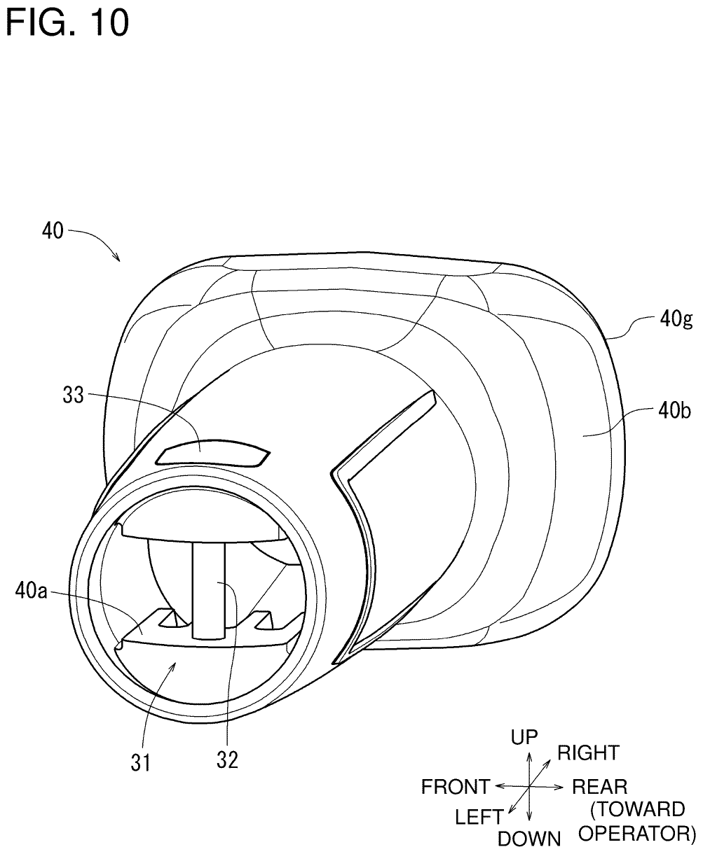

As shown in FIGS. 5 and 6, the distal portion 30 includes a support shaft 30a at the left end. The support shaft 30a has a predetermined width in the vertical direction. As shown in FIG. 10, the grip body 40 has a support space 40a at the left end. The support space 40a has a predetermined width in the vertical direction. A single connecting shaft 32 extends between the upper and lower surfaces defining the support space 40a. The support shaft 30a is placed through the support space 40a to connect the grip body 40 to the distal portion 30 in the connecting portion 31.

A connecting shaft 32 is placed through the support shaft 30a in the connecting portion 31. The grip body 40 is connected to the base 10 to be tiltable about the connecting shaft 32 in the front-rear direction (the direction along the striking axis P). The upper and lower ends of the connecting shaft 32 are supported on caps 33. The upper cap 33 is elastically fitted in a recess on the upper surface of the grip body 40. The lower cap 33 is elastically fitted in a recess on the lower surface of the grip body 40.

The grip body 40 has an opening portion 40b at the right end. The opening portion 40b flares laterally. The opening portion 40b is substantially covered with the flange 16. The laterally flaring opening portion 40b defines the upper end of a gripping portion, increasing the grippability of the auxiliary grip 1.

As shown in FIGS. 5 to 8, the opening portion 40b accommodates the shock absorber 20 and the cushioning member 35 in its inner space. The shock absorber 20 includes two elastic members 21 and 22 and four pushers 23, 24, 25, and 26. Two holders 17 and 18 are integral with the left side surface of the flange 16. Each of the holders 17 and 18 is a rectangular recess. The two holders 17 and 18 are vertically symmetric with each other. The upper holder 17 is open upward. The lower holder 18 is open downward.

The holder 17 accommodate the single elastic member 21, and the holder 18 accommodates the single elastic member 22. Each of the elastic members 21 and 22 is accommodated with its urging direction aligned with the direction along the striking axis P (front-rear direction). The elastic members 21 and 22 are compression coil springs. The four pushers 23, 24, 25, and 26 are shafts of the same size. The pushers 23, 24, 25, and 26 respectively include front flanges 23a, 24a, 25a, and 26a at their front ends and rear flanges 23b, 24b, 25b, and 26b at their rear ends.

The rear flange 23b of the front pusher 23 is in contact with a front portion 21a of the upper elastic member 21 (a first elastic member in a portion in a first direction). The front flange 24a of the rear pusher 24 is in contact with a rear portion 21b of the upper elastic member 21. The rear flange 25b of the front pusher 25 is in contact with a front portion 22a of the lower elastic member 22 (a second elastic member in a portion in a second direction). The front flange 26a of the rear pusher 26 is in contact with the rear portion 22b of the lower elastic member 22.

The elastic members 21 and 22 on the portions of the base 10 in the first and second directions reduce twisting of the elastic members 21 and 22, achieving stable grippability of the grip body 40. The elastic member 21 in the portion in the first direction and the elastic member 22 in the portion in the second direction vertically overlap each other to reduce the size of the shock absorber 20 in the direction along the striking axis P.

The rear flange 23b in contact with the elastic member 21 has a tab 23c. The front flange 24a in contact with the elastic member 21 has a tab 24c. The rear flange 25b in contact with the elastic member 22 has a tab 25c. The front flange 26a in contact with the elastic member 22 has a tab 26c. The tabs 23c and 24c are engaged with the inner circumference of the elastic member 21. The tabs 25c and 26c are engaged with the inner circumference of the elastic member 22. The tab 23c is engaged with the front portion 21a of the elastic member 21, and the tab 24c is engaged with the rear portion 21b of the elastic member 21. Thus, the elastic member 21 is held between the front pusher 23 and the rear pusher 24. The tab 25c is engaged with the front portion 22a of the elastic member 22, and the tab 26c is engaged with the rear portion 22b of the elastic member 22. Thus, the elastic member 22 is held between the front pusher 25 and the rear pusher 26.

The holder 17 has a holding groove 17b on a front wall 17a and a holding groove 17d on a rear wall 17c. The holder 18 has a holding groove 18b on a front wall 18a and a holding groove 18d on a rear wall 18c.

The upper front pusher 23 is received in the holding groove 17b. The upper rear pusher 24 is received in the holding groove 17d. The lower front pusher 25 is received in the holding groove 18b. The lower rear pusher 26 is received in the holding groove 18d. The upper front pusher 23 and the upper rear pusher 24 are respectively received in the holding grooves 17b and 17d to be displaceable in the axial direction (front-rear direction). The lower front pusher 25 and the lower rear pusher 26 are respectively received in the holding grooves 18b and 18d to be displaceable in the axial direction (front-rear direction).

All the front flanges 23a, 24a, 25a, and 26a and the rear flanges 23b, 24b, 25b, and 26b have diameters with which they cannot pass through the respective holding grooves 17b, 17d, 18b, and 18d. This restricts the frontward displacement of the front pushers 23 and 25 and the rearward displacement of the rear pushers 24 and 26.

In an initial state in which the grip body 40 receives no load in the direction along the striking axis P as shown in FIG. 5, the grip body 40 is at a neutral position (initial position) at which the grip body 40 is parallel to the distal portion 30. In the initial state shown in FIGS. 5 to 8, under an urging force from the upper elastic member 21, the rear flange 23b of the front pusher 23 is pressed against the rear surface of the front wall 17a, and the front flange 24a of the rear pusher 24 is pressed against the front surface of the rear wall 17c. Under an urging force from the lower elastic member 22, the rear flange 25b of the front pusher 25 is pressed against the rear surface of the front wall 18a, and the front flange 26a of the rear pusher 26 is pressed against the front surface of the rear wall 18c. Thus, the elastic member 21 assembled between the front pusher 23 and the rear pusher 24 and the elastic member 22 assembled between the front pusher 25 and the rear pusher 26 are in an urged state in which the elastic members 21 and 22 are compressed to be shorter than their free lengths.

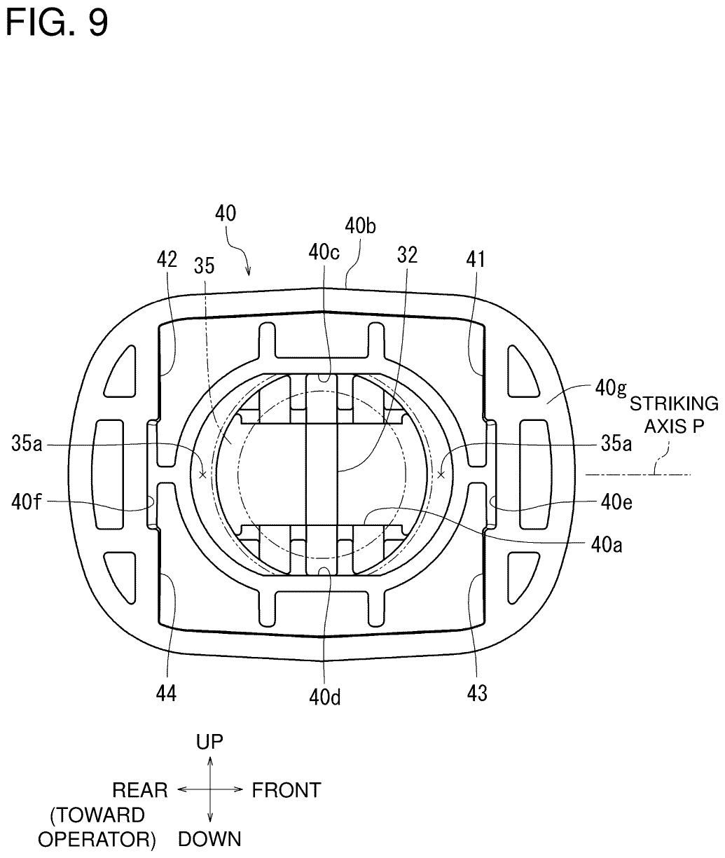

As shown in FIGS. 5 and 9, the grip body 40 has four contact surfaces 41 to 44 on the inner surface of the opening portion 40b. In the initial state, the front flange 23a of the upper front pusher 23 faces the upper front contact surface 41 with a small clearance between them. The rear flange 24b of the upper rear pusher 24 faces the rear contact surface 42 with a small clearance between them. The front flange 25a of the lower front pusher 25 faces the lower front contact surface 43 with a small clearance between them. The rear flange 26b of the lower rear pusher 26 faces the lower rear contact surface 44 with a small clearance between them.

In the initial state, neither the upper elastic member 21 nor the lower elastic member 22 thus applies an urging force to the grip body 40.

A distance d1 between the front contact surface 41 and the front wall 17a of the holder 17, a distance d2 between the rear contact surface 42 and the rear wall 17c of the holder 17, a distance d3 between the front contact surface 43 and the front wall 18a of the holder 18, and a distance d4 between the rear contact surface 44 and the rear wall 18c of the holder 18 vary based on the tilting operation of the grip body 40 about the connecting shaft 32.

The distance D1 between the front contact surface 41 and the rear contact surface 42 and the distance D2 between the front contact surface 43 and the rear contact surface 44 are both constant, independently of the tilting operation of the grip body 40. The distance D1 between the upper front contact surface 41 and the upper rear contact surface 42 is initially set to be slightly larger than the distance between the front flange 23a and the rear flange 24b. In the initial state, small clearances are thus left between the front contact surface 41 and the front flange 23a of the front pusher 23 and between the rear contact surface 42 and the rear flange 24b of the rear pusher 24.

The distance D2 between the lower front contact surface 43 and the rear contact surface 44 is initially set to be slightly larger than the distance between the front flange 25a and the rear flange 26b. In the initial state, small clearances are thus left between the front contact surface 43 and the front flange 25a of the front pusher 25 and between the rear contact surface 44 and the rear flange 26b of the rear pusher 26.

Each of the distances D1 and D2 is, for example, about 42 mm. This reduces the size of the shock absorber 20 in the direction along the striking axis P (the longitudinal direction of the tool body 51) and reduces the size of the opening portion 40b of the grip body 40.

The front pusher 23 and the rear pusher 24 are held in the holder 17 under an urging force from the elastic member 21. The front pusher 25 and the rear pusher 26 are held in the holder 18 under an urging force from the elastic member 22. This allows the shock absorber 20 to enter, during assembling of the grip body 40 to the base 10, the inner space of the grip body 40 with the four pushers 23, 24, 25, and 26 being held on the elastic members 21 and 22. This achieves reliable assembling of the grip body 40.

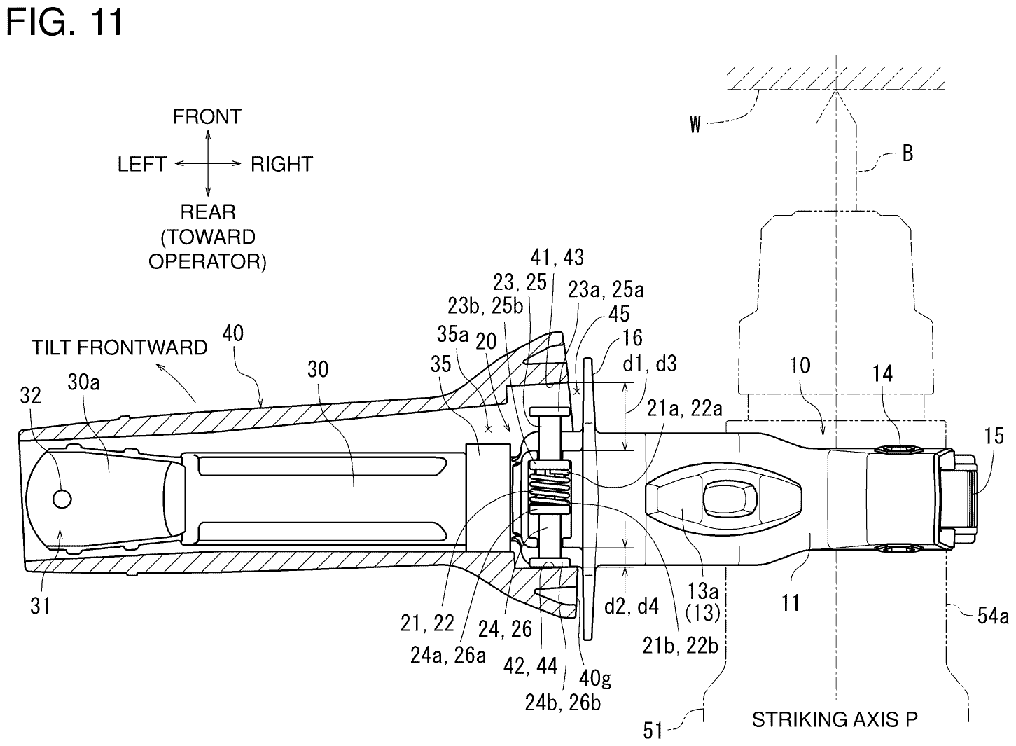

For example, the bit B is pressed against the workpiece W by the operator during operation. The auxiliary grip 1 held by the operator is thus pushed frontward in the direction along the striking axis P. The grip body 40 thus tilts about the connecting shaft 32 in the direction along the striking axis P (frontward) relative to the base 10 as shown in FIG. 11. In response to the grip body 40 tilting frontward, the rear pushers 24 and 26 are pushed frontward by the respective rear contact surfaces 42 and 44 to be displaced frontward relative to the holders 17 and 18. Thus, the distances d2 and d4 decrease. In this state, the front pushers 23 and 25 are not displaced relative to the respective holders 17 and 18. The elastic members 21 and 22 are thus compressed by the displacement of the respective rear pushers 24 and 26, producing an urging force acting rearward on the grip body 40 in the direction along the striking axis P. In this state, the distances d1 and d3 increase, separating the front contact surfaces 41 and 43 from the front pushers 23 and 25. Thus, no force acts from the grip body 40 onto the elastic members 21 and 22 in the direction along the striking axis P.

In response to the grip body 40 tilting frontward, the upper and lower rear pushers 24 and 26 are pushed frontward by the respective rear contact surfaces 42 and 44 of the grip body 40 in the shock absorber 20. The rear flange 23b then comes in contact with the rear surface of the front wall 17a, and the rear flange 25b comes in contact with the rear surface of the front wall 18a. This restricts the frontward movement of the upper and lower front pushers 23 and 25. The frontward displacement of the elastic members 21 and 22 is thus restricted, applying an urging force from the elastic members 21 and 22 to the base 10 through the respective front pushers 23 and 25.

The rear pushers 24 and 26 push the respective rear portions 21b and 22b of the elastic members 21 and 22 frontward. The front pushers 23 and 25 restrict the frontward displacement of the respective front portions 21a and 22a of the elastic members 21 and 22.

The grip body 40 constantly receives, from the operator, a pressing force acting frontward (toward the workpiece W) in the direction along the striking axis P. This pushes the rear pusher 24 frontward against the urging force from the elastic member 21, and pushes the rear pusher 26 frontward against the urging force from the elastic member 22. The grip body 40 thus receives an urging force acting rearward in the direction along the striking axis P. This absorbs an impact generated by the tool body 51 performing striking.

When the operator stops pushing the grip body 40 frontward, the grip body 40 returns to the initial position shown in FIG. 5 under the urging force from the elastic members 21 and 22. At the initial position, the movement of the front pushers 23 and 25 and the rear pushers 24 and 26 are restricted under the urging force from the elastic members 21 and 22. This restricts the tilting of the grip body 40 in the front-rear direction. The grip body 40 is thus held at the neutral position at which the grip body 40 is parallel to the distal portion 30.

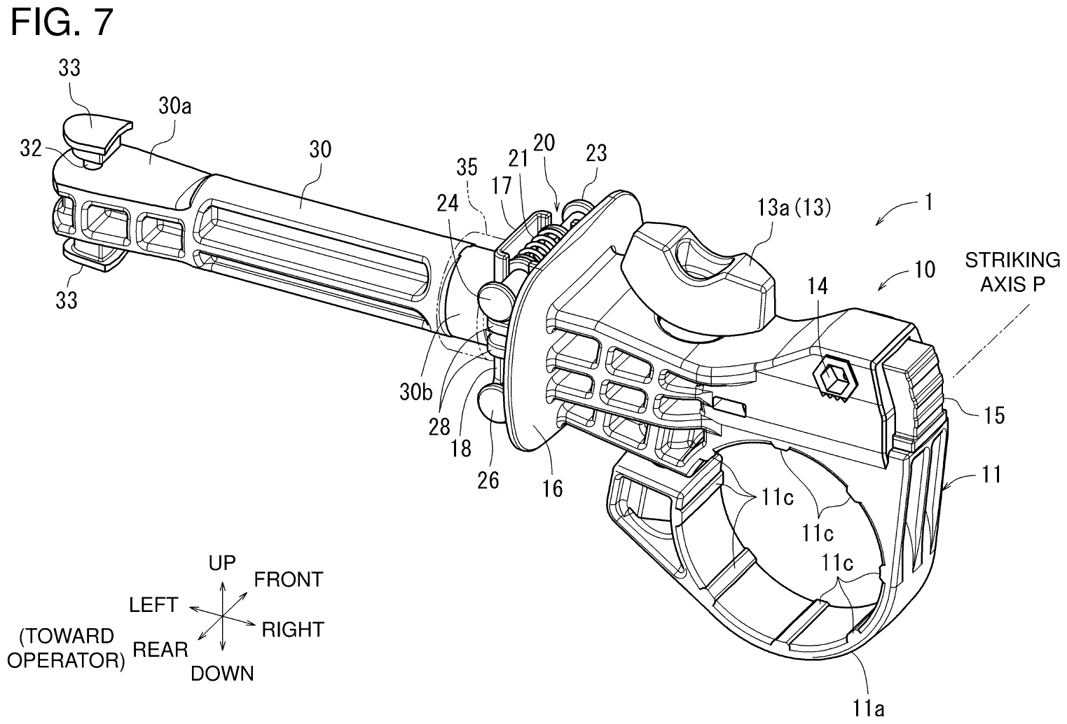

The single cushioning member 35 is attached adjacent to the left of the shock absorber 20. The cushioning member 35 is annular. The distal portion 30 has a cushioning groove 30b at its basal end. The cushioning member 35 is received in the cushioning groove 30b. As shown in FIG. 7, the cushioning groove 30b is deeper in the front-rear direction and shallower in the vertical direction. Thus, the cushioning member 35 deforms in a vertically elongated oval shape when attached. The attached cushioning member 35 is thus shorter in the front-rear direction than in the vertical direction.

As shown in FIG. 9, the grip body 40 has upper and lower flat surfaces 40c and 40d on its inner peripheral surface. The flat surfaces 40c and 40d are elastically in contact with the top and bottom of the cushioning member 35 elongated vertically. Thus, the cushioning member 35 is constantly pressed elastically against the grip body 40 in the vertical direction when assembled. The cushioning member 35 is attached to the inner peripheral surface of the grip body 40 with clearances 35a between the cushioning member 35 and the inner peripheral surface of the grip body 40 in the front-rear direction.

The grip body 40 constantly receives, from the operator, a pressing force acting frontward in the direction along the striking axis P, elastically deforming the elastic members 21 and 22. This absorbs an impact generated in the direction along the striking axis P when striking is performed. The clearances 35a are left between a front portion of the cushioning member 35 and the inner peripheral surface of the grip body 40 and between a rear portion of the cushioning member 35 and the inner peripheral surface of the grip body 40. The elastic members 21 and 22 thus deform elastically while the grip body 40 is tilting in the direction along the striking axis P, eliminating one of the front or rear clearance 35a. The cushioning member 35 then comes in contact with the inner peripheral surface of the grip body 40.

This reduces the momentum of the grip body 40 during the tilting operation. The impact on the base 10 is thus reduced when the grip body 40 comes in contact with the base 10.

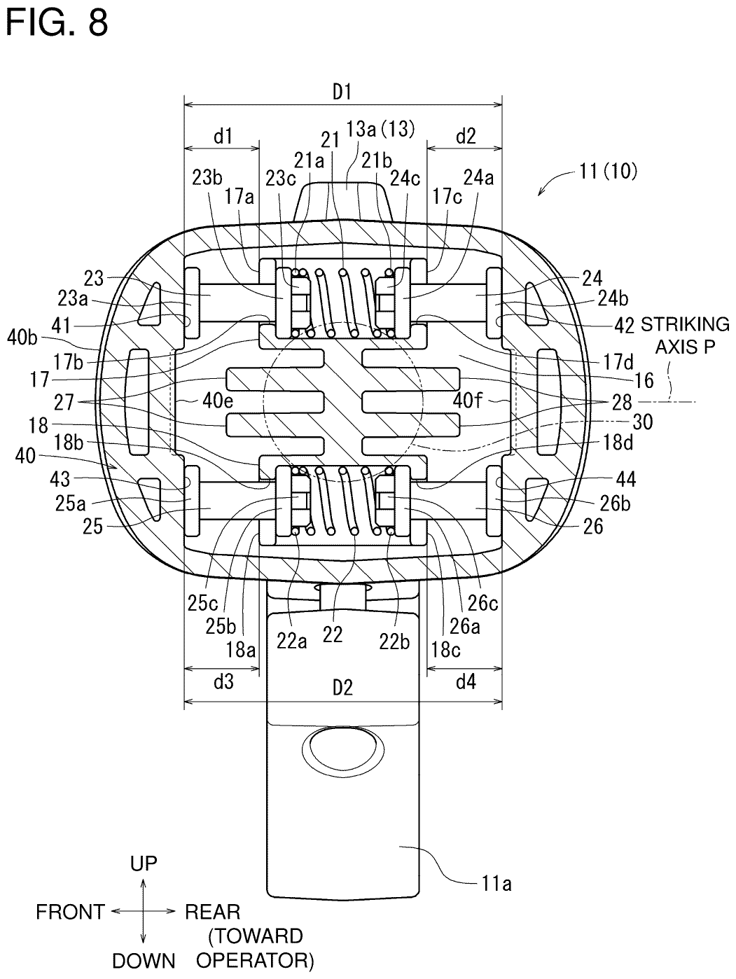

As shown in FIGS. 8 and 9, the grip body 40 includes a front restrictor 40e and a rear restrictor 40f on the inner surface of the opening portion 40b. The front restrictor 40e and the rear restrictor 40f face each other in the front-rear direction. Both the front restrictor 40e and the rear restrictor 40f are flat surfaces. The front restrictor 40e and the rear restrictor 40f are inclined at a slight angle with respect to the direction in which the base 10 extends (lateral direction). The front restrictor 40e and the rear restrictor 40f are thus inclined rightward in a direction in which they are separate from each other (frontward or rearward).

The flange 16 includes two front receivers 27 and two rear receivers 28 on the left side surface. Each front receiver 27 has a flat-plate shape. The two front receivers 27 are arranged parallel to each other in the vertical direction. The front receivers 27 extend frontward from the distal portion 30. Each rear receiver 28 has a flat-plate shape. The rear receivers 28 extend rearward from the distal portion 30.

When the operator holds the auxiliary grip 1 and presses the auxiliary grip 1 frontward in the direction along the striking axis P as shown in FIG. 11, the grip body 40 tilts relatively frontward. The rear restrictor 40f then comes in contact with the rear receivers 28. The rear receivers 28 are slightly inclined with respect to the direction in which the base 10 extends. The rear receivers 28 thus have their surfaces in contact with the rear restrictor 40f. This restricts the frontward tilting range of the grip body 40.

In response to the grip body 40 tilting frontward in the direction along the striking axis P, the elastic members 21 and 22 are pushed frontward by the respective rear pushers 24 and 26 and deform elastically. This absorbs an impact generated by the tool body 51 performing striking. The rear restrictor 40f comes in contact with the rear receivers 28 before the elastic members 21 and 22 deform elastically at most and are compressed. The impact on the grip body 40 is thus efficiently absorbed within the elastic range of the elastic members 21 and 22.

The opening portion 40b of the grip body 40 has a curved right end 40g. The right end 40g is curved in a direction in which its front end and rear end are spaced away from the flange 16. The right end 40g faces the flange 16 of the base 10. The curved right end 40g avoids coming in contact with the flange 16 when the grip body 40 tilts in the front-rear direction. This permits the tilting operation of the grip body 40 at a sufficient angle.

As shown in FIG. 12, the auxiliary grip 1 can be attached in the right lateral orientation in which the auxiliary grip 1 protrudes rightward from the tool body 51. The auxiliary grip 1 can be detached from the grip mount 54a to be inverted 180 degrees rightward, in a plan view, from the left lateral orientation shown in FIG. 11. The auxiliary grip 1 can then be attached in the right lateral orientation shown in FIG. 12. The auxiliary grip 1 in the right lateral orientation is held by the operator with, for example, the right hand.

In the right lateral orientation in which the auxiliary grip 1 is inverted 180 degrees from the left lateral orientation in the lateral direction perpendicular to the striking axis P, the front pushers 23 and 25 and the rear pushers 24 and 26 are inverted from the right lateral orientation in the front-rear direction. In the right lateral orientation, the front pushers 23 and 25 are thus located rearward from the respective rear pushers 24 and 26. In the right lateral orientation, the front flanges 23a and 25a of the respective front pushers 23 and 25 are located rearward. More specifically, the front flanges 23a and 25a are located rearward from the respective rear flanges 23b and 25b. The front flanges 24a and 26a of the respective rear pushers 24 and 26 are located frontward. More specifically, the front flanges 24a and 26a are located rearward from the respective rear flanges 24b and 26b.

In the right lateral orientation, the elastic members 21 and 22 are inverted in the front-rear direction. Thus, the front portions 21a and 22a are located rearward from the respective rear portions 21b and 22b. In the right lateral orientation, the grip body 40 is inverted in the front-rear direction. Thus, the front contact surfaces 41 and 43 are located rearward from the respective rear contact surfaces 42 and 44.

In response to the auxiliary grip 1 in the right lateral orientation being pushed frontward (toward the workpiece W) in the direction along the striking axis P, the grip body 40 tilts frontward about the connecting shaft 32 relative to the base 10 in the direction along striking axis P. The front restrictor 40e then comes in contact with the front receivers 27. The front receivers 27 are slightly inclined with respect to the direction in which the base 10 extends. The front receivers 27 thus have their surfaces in contact with the front restrictor 40e. This restricts the frontward tilting range of the grip body 40.

In response to the grip body 40 tilting frontward, the front pushers 23 and 25 are pushed frontward by the respective front contact surfaces 41 and 43, and are displaced frontward relative to the holders 17 and 18. The distances d1 and d3 thus decrease. In this state, the rear pushers 24 and 26 are not displaced relative to the respective holders 17 and 18. The elastic members 21 and 22 are thus compressed by the displacement of the respective front pushers 23 and 25, producing an urging force acting rearward on the grip body 40 in the direction along the striking axis P. In this state, the distances d2 and d4 increase, separating the rear contact surfaces 42 and 44 from the respective rear pushers 24 and 26. Thus, no force acts from the grip body 40 onto the elastic members 21 and 22 in the direction along the striking axis P.

In response to the grip body 40 tilting frontward, the upper and lower front pushers 23 and 25 in the shock absorber 20 are pushed frontward by the respective front contact surfaces 41 and 43 of the grip body 40. The front flange 24a then comes in contact with the rear wall 17c of the holder 17, and the front flange 26a comes in contact with the rear wall 18c of the holder 18. This restricts the frontward movement of the front flanges 24a and 26a. The frontward displacement of the elastic members 21 and 22 is thus restricted, applying an urging force from the elastic members 21 and 22 to the base 10 through the respective front pushers 23 and 25.

The front pushers 23 and 25 push the respective front portions 21a and 22a of the elastic members 21 and 22 frontward. The rear pushers 24 and 26 restrict the frontward displacement of the respective rear portions 21b and 22b of the elastic members 21 and 22.

The grip body 40 constantly receives, from the operator, a pressing force acting frontward (toward the workpiece W) in the direction along the striking axis P. This pushes the front pusher 23 frontward against the urging force from the elastic member 21, and pushes the front pusher 25 frontward against the urging force from the elastic member 22. The grip body 40 thus receives an urging force acting rearward in the direction along the striking axis P. This absorbs an impact generated by the tool body 51 performing striking.

When the operator stops pushing the grip body 40 frontward, the grip body 40 returns to its initial position under the urging force from the elastic members 21 and 22. At the initial position, the movement of the front pushers 23 and 25 and the rear pushers 24 and 26 are restricted under the urging force from the elastic members 21 and 22. This restricts the tilting of the grip body 40 in the front-rear direction. The grip body 40 is thus held at the neutral position at which the grip body 40 is parallel to the distal portion 30.

In the right lateral orientation, the elastic members 21 and 22 are thus pushed frontward by the respective front pushers 23 and 25 and elastically deform in response to the grip body 40 tilting frontward in the direction along the striking axis P. This absorbs an impact generated by the tool body 51 performing striking. The front restrictor 40e comes in contact with the front receivers 27 before the elastic members 21 and 22 deform elastically at most and are compressed. The impact on the grip body 40 is thus efficiently absorbed within the elastic range of the elastic members 21 and 22.

The elastic members 21 and 22 both urge the grip body 40 rearward (toward the operator) in the direction along the striking axis P both in the left lateral orientation and in the right lateral orientation. The elastic members 21 and 22 urge the grip body 40 toward the operator in either orientation. Thus, the grip body 40 is pushed frontward in the direction along the striking axis P by the operator against the urging force from the elastic members 21 and 22 in either orientation.

To use both the elastic members 21 and 22 in both the left and right lateral orientations in this embodiment, the holders 17 and 18, the front pushers 23 and 25 and the rear pushers 24 and 26, the front contact surfaces 41 and 43 and the rear contact surfaces 42 and 44, the front receivers 27 and the rear receivers 28, and the front restrictor 40e and the rear restrictor 40f are arranged symmetric with each other in the front-rear direction in the shock absorber 20.

The auxiliary grip 1 according to the embodiment includes the base 10 to extend in the direction intersecting with the striking axis P of the striking tool 50, and the grip body 40 covering the base 10. The elastic members 21 and 22 held by the base 10 can urge the grip body 40 in two directions along the striking axis P. Both in the left lateral orientation in which the grip body 40 extends leftward and in the right lateral orientation in which the grip body 40 extends rightward relative to the striking axis P, the grip body 40 is urged by the elastic members 21 and 22 toward the operator. This structure allows the grip body 40 to be urged in the two directions along the striking axis P.

Thus, the grip body 40 can be urged in the two directions along the striking axis P by the elastic members 21 and 22, reducing the size of the auxiliary grip.

The base 10 includes the basal portion 11 attachable to the tool body 51 in the striking tool 50, and a distal portion 30 to which the grip body 40 is connected to be tiltable in the direction along the striking axis P. The basal portion 11 receives the elastic members 21 and 22. The base 10 includes the connecting portion 31 in which the grip body 40 is connected to the distal portion 30 spaced from the elastic members 21 and 22. Thus, the elastic members 21 and 22 are arranged relatively close to the tool body 51 whereas the connecting portion 31 is located relatively distant from the tool body 51. This structure efficiently absorbs an impact generated by the tool body 51 performing striking.

The elastic members 21 and 22 are displaced from the base 10 and partially overlapping the base 10 in the vertical direction intersecting with the direction in which the base 10 extends. This structure reliably reduce the size of the auxiliary grip in the direction along the striking axis P.

The shock absorber 20 includes the elastic member 21 (first elastic member) in an upper portion of the base 10 (the portion of the base 10 in the first direction) and the elastic member 22 (second elastic member) in a lower portion of the base 10 (the portion of the base in the second direction) in a direction opposite to the first direction. The elastic members 21 and 22 located in both the upper and lower portions of the base 10 reduce twisting of the elastic members 21 and 22, achieving stable grippability of the grip body 40.

The elastic members 21 and 22 are held in the respective holders 17 and 18 under the urging force from the elastic members 21 and 22. This structure prevents the elastic members 21 and 22 from slipping off the respective holders 17 and 18 during assembly. This structure achieves easy assembly of the grip body 40 to the base 10. In addition, this structure increases an initial reaction force of the elastic members 21 and 22, allowing the operator to hold the auxiliary grip 1 more comfortably.

The shock absorber 20 includes the pushers 23, 24, 25, and 26 each having one end in contact with the corresponding elastic member 21 or 22 and the other end in contact with the inner surface of the grip body 40. Thus, the urging force from the elastic members 21 and 22 acts on the inner surface of the grip body 40 through the pushers 23, 24, 25, and 26.

The shock absorber 20 includes the front pushers 23 and 25 in contact with the respective front portions 21a and 22a of the elastic members 21 and 22 and the rear pushers 24 and 26 in contact with the respective rear portions 21b and 22b of the elastic members 21 and 22. In response to the front pushers 23 and 25 displaced rearward against the urging force from the respective elastic members 21 and 22, the grip body 40 is urged frontward in the direction along the striking axis P. In response to the rear pushers 24 and 26 displaced frontward against the urging force from the respective elastic members 21 and 22, the grip body 40 is urged rearward in the direction along the striking axis P.

The base 10 includes the elastic members 21 and 22 and the holders 17 and 18 holding the pushers 23, 24, 25, and 26. The holder 17 includes the walls 17a and 17c that restrict the movement of the respective pushers 23 and 24 in the direction along the striking axis P. The holder 18 includes the walls 18a and 18c that restrict the movement of the pushers 25 and 26 in the direction along the striking axis P. Thus, the elastic members 21 and 22 and the pushers 23, 24, 25, and 26 are together held in the holders 17 and 18, reducing the size of the auxiliary grip 1. Restricting the movement of the pushers 23, 24, 25, and 26 allows the elastic members 21 and 22 to reliably apply an urging force to the grip body 40.

The cushioning member 35 is located between the base 10 and the grip body 40 with the clearances 35a between the base 10 and the grip body 40. In response to the grip body 40 being displaced against the elastic force from the elastic members 21 and 22 in the front-rear direction to eliminate the clearance 35a, the cushioning member 35 is pressed by the displaced grip body 40 and deforms elastically. This structure reduces an impact on the base 10 resulting from tilting of the grip body 40.

The cushioning member 35 is constantly pressed to deform between the grip body 40 and the base 10 in the vertical direction perpendicular to the striking axis P. This structure reduces rattling of the grip body 40, achieving stable grippability of the grip body 40.

The auxiliary grip 1 includes a restrictor that restricts tilting of the grip body 40 relative to the base 10. The restrictor includes the front restrictor 40e and the rear restrictor 40f located on the grip body 40, and the front receivers 27 and the rear receivers 28 located on the base 10. The front restrictor 40e comes in contact with the front receivers 27, and the rear restrictor 40f comes in contact with the rear receivers 28. The front restrictor 40e and rear restrictor 40f on the grip body 40 each have an angle of inclination with respect to the direction in which the base 10 extends. In response to the grip body 40 tilting frontward or rearward, the surface of the front restrictor 40e comes in contact with the front receivers 27, or the surface of the rear restrictor 40f comes in contact with the rear receivers 28. This structure reliably restricts the maximum angle of inclination of the grip body 40 with respect to the base 10.

The embodiment may be modified further. In the above embodiment, for example, the shock absorber 20 includes two elastic members 21 and 22 arranged in the upper and lower portions. In some embodiments, one or more elastic members may be located in one of the upper and lower portions. In some embodiments, a single elastic member may be located at the same level as the distal portion 30 (at a level at which the center of the distal portion 30 extends in the front-rear direction).

In the above embodiment, the front restrictor 40e and the rear restrictor 40f on the grip body 40 are inclined with respect to the direction in which the base 10 extends. In some embodiments, the front receivers 27 and the rear receivers 28 on the base 10 may also be inclined. In some embodiments, both the front and rear restrictors and the front and rear receivers may be inclined to have their surfaces in contact with each other. One or both of the restrictors on the grip body and the receivers on the base may have curved surfaces in place of the inclined flat surfaces.

In the above embodiment, the elastic members 21 and 22 are compression coil springs. In some embodiments, the elastic members may be leaf springs, urethane rubber, or gas dampers in place of the compression coil springs.

In the above embodiment, the connecting portion 31 at the left end of the distal portion 30 of the base 10 connects the grip body 40 to allow the grip body 40 to be tiltable frontward and rearward. The shock absorber 20 including the elastic members 21 and 22 and the pushers 23, 24, 25, and 26 are located on the basal portion of the base 10. In some embodiments, the connecting portion 31 and the shock absorber 20 may be located reversely to have the shock absorber at the left end of the distal portion 30 and the connecting portion for tilting at the basal portion.

In the above embodiment, the grip body 40 is connected to the distal portion 30 of the base 10 with the connecting shaft 32. In some embodiments, the connecting shaft may be held to be slidable (translatable) in the front-rear direction relative to the support shaft 30a, to the support space 40a in the grip body 40, or to both. This structure more reliably reduces an impact on the grip body 40.

In the above embodiment, the striking tool is a hammer drill that performs striking while rotating the drill bit B. In some embodiments, the auxiliary grip 1 may be used in a striking tool that simply performs striking on a tip tool, such as a hammer tool for chipping.

In the above embodiment, the auxiliary grip 1 is attachable to the tool body 51. In some embodiments, the shock absorber 20 may be used in an auxiliary grip undetachable from and integral with the tool body.

The striking tool may be a direct current (DC) tool powered by the rechargeable battery pack 70 or an alternating current (AC) tool using utility power.

### REFERENCE SIGNS LIST

1 auxiliary grip
10 base
11 basal portion
11a fastener
11c engagement protrusion
13 fastening screw
13a projection
14 auxiliary tool mount
15 lock button
16 flange
17 (upper) holder
17a front wall
17b holding groove
17c rear wall
17d holding groove
18 (lower) holder
18a front wall
18b holding groove
18c rear wall
18d holding groove
20 shock absorber
21 (upper) elastic member
21a front portion
21b rear portion
22 (lower) elastic member
22a front portion
22b rear portion
23 (upper) front pusher
23a front flange
23b rear flange
23c tab
24 (upper) rear pusher
24a front flange
24b rear flange
24c tab
25 (lower) front pusher
25a front flange
25b rear flange
25c tab
26 (lower) rear pusher
26a front flange
26b rear flange
26c tab
27 front receiver
28 rear receiver
30 distal portion
30a support shaft
30b cushioning groove
31 connecting portion
32 connecting shaft
33 cap
35 cushioning member
35a clearance
40 grip body
40a support space
40b opening portion
40c, 40d flat surface
40e front restrictor
40f rear restrictor
40g right end
41 (upper) front contact surface
42 (upper) rear contact surface
43 (lower) front contact surface
44 (lower) rear contact surface
50 striking tool (hammer drill)
51 tool body
52 handle
53 vibration isolator
54 body housing
54a grip mount
54b engagement recess
55 chuck
56 grip
57 handle base
58 switch lever
59 switch body
60 striking assembly
61 electric motor
M motor axis
62 bevel gear
63 countershaft
63a gear
J axis of countershaft 63
64 power converter
65 piston
66 striker
B drill bit
P striking axis
W concrete wall surface (workpiece)
67 tool holder
67a holder gear
68 intermediate member
70 battery pack
71 battery mount
72 controller

What is claimed is:

1. An auxiliary grip attachable to a striking tool, the auxiliary grip comprising:
a base to extend in a direction intersecting with a striking axis of the striking tool, the base including at least one elastic member, and
a grip body covering the base, the grip body being held by the base to be urged by the at least one elastic member in two directions along the striking axis.

2. The auxiliary grip according to claim 1, wherein
the base includes
a basal portion attachable to the striking tool and receiving the at least one elastic member,
a distal portion to which the grip body is connected to be tiltable in a direction along the striking axis, and
a connecting portion in which the grip body is connected to the distal portion spaced from the at least one elastic member.

3. The auxiliary grip according to claim 1, wherein
the at least one elastic member is displaced from the base and partially overlapping the base in a vertical direction intersecting with a direction in which the base extends.

4. The auxiliary grip according to claim 1, wherein
the at least one elastic member includes
a first elastic member in a portion of the base in a first direction, and
a second elastic member in a portion of the base in a second direction opposite to the first direction.

5. The auxiliary grip according to claim 1, wherein
the base includes a holder holding the at least one elastic member under an urging force from the at least one elastic member.

6. The auxiliary grip according to claim 1, further comprising:
at least one pusher having a first end in contact with the at least one elastic member and a second end in contact with an inner surface of the grip body.

7. The auxiliary grip according to claim 6, wherein
the at least one pusher includes
a front pusher in contact with a front portion of the at least one elastic member, and
a rear pusher in contact with a rear portion of the at least one elastic member.

8. The auxiliary grip according to claim 6, wherein
the holder holds the at least one pusher, and
the holder restricts movement of the at least one pusher in a direction along the striking axis.

9. The auxiliary grip according to claim 1, further comprising:
a cushioning member between the base and the grip body with a clearance between the base and the grip body,
wherein in response to the grip body being displaced against an elastic force from the at least one elastic member to eliminate the clearance, the cushioning member is pressed by the displaced grip body and deforms elastically.

10. The auxiliary grip according to claim 9, wherein
the cushioning member is constantly pressed to deform between the grip body and the base in a direction perpendicular to the striking axis.

11. The auxiliary grip according to claim 1, further comprising:
a restrictor restricting tilting of the grip body relative to the base; and
a receiver to be in contact with the restrictor,
wherein the restrictor is located on one of the base or the grip body,
the receiver is located on another of the base or the grip body, and
the restrictor has a surface to be in contact with the receiver.

12. The auxiliary grip according to claim 2, wherein
the at least one elastic member is displaced from the base and partially overlapping the base in a vertical direction intersecting with a direction in which the base extends.

13. The auxiliary grip according to claim 2, wherein
the at least one elastic member includes
a first elastic member in a portion of the base in a first direction, and
a second elastic member in a portion of the base in a second direction opposite to the first direction.

14. The auxiliary grip according to claim 3, wherein
the at least one elastic member includes
a first elastic member in a portion of the base in a first direction, and
a second elastic member in a portion of the base in a second direction opposite to the first direction.

15. The auxiliary grip according to claim 2, wherein
the base includes a holder holding the at least one elastic member under an urging force from the at least one elastic member.

16. The auxiliary grip according to claim 3, wherein
the base includes a holder holding the at least one elastic member under an urging force from the at least one elastic member.

17. The auxiliary grip according to claim 4, wherein
the base includes a holder holding the at least one elastic member under an urging force from the at least one elastic member.

18. The auxiliary grip according to claim 2, further comprising:
at least one pusher having a first end in contact with the at least one elastic member and a second end in contact with an inner surface of the grip body.

19. The auxiliary grip according to claim 3, further comprising:
at least one pusher having a first end in contact with the at least one elastic member and a second end in contact with an inner surface of the grip body.

20. A striking tool, comprising:
the auxiliary grip according to claim 1.
